(19) United States
(12) Patent Application Publication
(10) Pub. No.: US 2018/0371632 A1
(43) Pub. Date: Dec. 27, 2018

(54) METHOD FOR PRODUCING A LITHIUM FILM

(71) Applicants: CLEAN LITHIUM CORPORATION, Yonkers, NY (US); RESEARCH FOUNDATION OF THE CITY UNIVERSITY OF NEW YORK, New York, NY (US)

(72) Inventors: Emilie Bodoin, Bedford Hills, NJ (US); Lawrence Ralph Swonger, Lititz, PA (US); Olha Mashtalir, Tarrytown, NY (US); Minh Nguyen, New York, NY (US); Stephen O'Brien, New York, NY (US)

(21) Appl. No.: 15/780,937

(22) PCT Filed: Dec. 1, 2016
(86) PCT No.: PCT/US2016/064328

§ 371 Date: Jun. 1, 2018

Related U.S. Application Data
(60) Provisional application No. 62/262,438, filed on Dec. 3, 2015.

(51) Int. Cl. C25D 5/02; C25D 5/34; C25D 7/12; C25D 3/56; H01M 4/04; H01M 4/36; H01M 4/38; H01M 4/40; H01M 4/134; H01M 10/0525

(52) U.S. Cl. CPC C25D 5/02; C25D 5/34; C25D 7/12; C25D 3/56; H01M 10/0525; H01M 4/366; H01M 4/382; H01M 4/405; H01M 4/134; H01M 4/0404

(57) ABSTRACT

A high purity lithium metal thin film and a process for controlling the morphology of the high purity lithium metal thin film are provided. In a general embodiment, the present disclosure provides a high purity lithium metal thin film having a controlled thickness and morphology. The high purity lithium metal thin film is produced by electrolytic deposition of lithium using a selective lithium ion conducting layer. The morphology of the lithium metal thin film can be controlled by varying the current rate used for deposition. The present lithium metal films advantageously provide a high purity lithium metal film in which the thickness and/or morphology of the film can be altered depending on the desired application.

### BACKGROUND

The present disclosure generally relates to high purity lithium metal films with specific properties. More specifically, the present disclosure relates to high purity lithium metal films having a controlled thickness and morphology. The high purity lithium metal films have a thickness of 10 nm to hundreds of microns and a morphology selected from: smooth films, nanoparticles and nanorods.

Lithium metal is a promising high energy density battery anode material due to its high theoretical specific capacity (3860 mAh/g), low density (0.59 g/cm³), and low negative reduction potential (−3.040 V vs. SHE). Lithium metal has conventionally been used in primary batteries, whereas secondary batteries typically use lithium intercalated graphite anodes. Replacing such graphite anodes with lithium metal can provide a substantial increase in energy density of the battery since lithium metal has a theoretical capacity ten times as high as graphite.

However, safety concerns, poor cyclability and short lifetimes have limited the use of lithium metal in current secondary battery applications, in which cycling of the anode is necessary. These problems are primarily due to insufficient purity of lithium metal (in terms of base metals content, reactions in air with lithium to form nitrides and oxides, and other issues associated with impurities) and dendrite formation on the surface of the lithium metal. These problems can be addressed by using high purity lithium metal with smooth, uniform surfaces free of dendrites and non-lithium inclusions.

For battery applications, lithium metal is used mostly in a foil form. Lithium foil is traditionally produced from lithium carbonate using an electrolysis process with lithium chloride as a precursor. For example, in an electrolysis process described in U.S. Pat. No. 4,274,834 to Brown et al., lithium carbonate is converted to lithium chloride via reaction with hydrochloric acid, followed by a high temperature (380° C. to 400° C.) reduction of a eutectic lithium chloride and potassium chloride composite to form bulk lithium metal usually recovered as ingots.

Another electrolysis process for producing lithium foil is described in U.S. Pat. No. 4,724,055 to Le Roux et al. U.S. Pat. No. 4,724,055 is directed to a continuous process for the preparation of lithium by the electrolysis of lithium chloride contained in a mixture of molten salts. The process undesirably consumes a large amount of energy and produces chlorine gas, an extremely corrosive and toxic air pollutant, as a byproduct, which requires additional purification/safety steps.

To form lithium foils having a thickness between 50 μm and 200 μm, lithium metal ingots are mechanically processed via extrusion or rolling in air (usually in a low moisture environment in nitrogen/oxygen which react with lithium metal). However, this undesirably introduces more contaminants to the final product. The produced foils are cut into a desired size and shape and attached to a current collector (typically copper foil) to be further used as anodes in primary lithium metal batteries.

Conventional methods of forming lithium foil or thin films use high purity lithium metal as a precursor and are done under reduced pressures or require additional additives which limit the rate of lithium deposition. For example, smooth lithium thin films of high metal purity have been made via physical vapor deposition (PVD), also referred to as sputtering, vacuum evaporation, laser ablation, and ion plating, as described in European Patent No. 1,174,936 to Kugai et al. and U.S. Pat. No. 7,629,083 B2 to Cho et al. PVD techniques can produce thin films of high purity lithium metal in the range of 1-200 microns, but such methods require pressures of 1.33×10⁻⁴ Pa (1×10⁻⁶ Torr) or below, since oxidation of the thin alkali metal film or degradation thereof by moisture can occur in low vacuum.

The present disclosure provides a process that can produce dendrite-free lithium metal films having a controlled thickness and morphology. The dendrite-free lithium metal films are smooth and can be produced directly from a lithium carbonate source.

### SUMMARY

The present disclosure provides a method for manufacturing high purity lithium metal thin films deposited on a conductive substrate and having a controlled thickness and morphology. The present disclosure also provides a method for manufacturing high purity, dendrite-free lithium metal film-based electrodes that can be used for both primary and secondary lithium metal batteries without any additional processing, thus streamlining the battery manufacturing process.

In a general embodiment, the present disclosure provides a lithium metal film that is dendrite-free and optically smooth. The lithium metal film is obtained by electrolytically depositing lithium on a cathode using a selective lithium ion conducting layer. The morphology of the lithium metal film can be controlled by varying the current rate used for the deposition.

In an embodiment, the lithium metal film has a thickness of about 1 nm to about 1000 μm. The lithium metal film may have a thickness of about 1 nm or more and less than about 40 μm. Specifically, the lithium metal film may have a thickness of about 25 μm.

In an embodiment, the lithium metal film has a smooth surface morphology.

In another embodiment, the lithium metal film comprises spherical structures.

In an embodiment, the lithium metal film comprises compact, self aligned nano-rod structures. An advantage of the nano-rod morphology is that the compact uniform nano-rods can significantly reduce the real surface area of a lithium anode compared to the present supply of lithium. This is beneficial because the reduction of the surface area of the anode reduces the loss of lithium due to the chemical and electrochemical reactions between the lithium and the electrolyte in a battery. This particular morphology can increase capacity, cyclability and reduce impedance compared to traditional electrodes.

In an embodiment, the present disclosure provides a lithium metal film, that is optically smooth for d<λ/(8 cos θ), where d is a surface roughness (e.g., root-mean-square roughness height measured from a reference plane), λ is the wavelength of the incident illumination (200-1000 nm), and θ is the angle of incidence of this illumination.

In an embodiment, the present disclosure provides an electrode comprising: a substrate and a lithium metal film provided on the substrate. The lithium metal film is free of dendrites and is optically smooth.

In an embodiment, the substrate comprises a material that does not alloy with lithium. The substrate may comprise a material selected from the group consisting of: copper and stainless steel.

In an embodiment, the substrate is pre-treated by etching the substrate in concentrated sulfuric acid (98 wt %) for two seconds, rinsing the substrate with deionized water, and air drying the substrate before the lithium metal film is provided thereon.

In an embodiment, a lithium alloy is provided. The lithium alloy comprises a substrate and a lithium metal film provided on the substrate. The lithium metal film is free of dendrites and is optically smooth, and the substrate comprises a material that alloys with lithium.

In an embodiment, the substrate comprises a material that alloys with lithium. The substrate may comprise aluminum, tin, silicon, or any other metal that alloys with lithium.

In an embodiment, a battery is provided and includes a cathode, an anode, and an electrolyte. The lithium metal film is provided on at least one of the cathode and the anode. The lithium metal film is free of dendrites and is optically smooth.

In an embodiment, the battery is a lithium primary battery, a rechargeable lithium metal battery, or a microbattery.

In an embodiment, the present disclosure provides a method of obtaining a desired morphology of a lithium metal film. The method includes electrolytically depositing lithium metal using a selective lithium ion conducting layer, and controlling a current rate of the electrolytic deposition to obtain the desired morphology.

In an embodiment, the current rate is controlled to be within a range of 1 mA/cm² to 10 mA/cm².

An advantage of the present disclosure is to provide a high purity lithium metal film having a controlled thickness and morphology. The lithium metal film is obtained using a selective lithium ion conducting layer. By controlling the thickness and morphology to be within a desired range, the lithium film can be easily designed for specific applications.

Another advantage of the present disclosure is to provide a method for controlling the morphology of an electrolytically deposited high purity lithium metal film. The high purity lithium metal film is optically smooth and dendrite-free and, thus, can be used in batteries and other applications requiring high purity smooth lithium metal films.

Additional features and advantages are described herein, and will be apparent from the following Detailed Description and the figures.

### BRIEF DESCRIPTION OF THE FIGURES

FIG. 1 shows a schematic elevation view of a lithium producing cell structure disclosed in U.S. Patent Publication No. 2015/0014184 A1.

FIG. 2 shows a schematic detail of the lithium producing cell structure of FIG. 1.

FIG. 3 shows a schematic exploded detail of a lithium producing cell of U.S. Patent Publication No. 2015/0014184 A1.

FIG. 4 shows SEM images of lithium films electrolytically deposited.

FIG. 5 shows photographs of lithium films electrolytically deposited on copper substrates at different current rates of −1, −3, −5, −10, and −15 mA/cm².

FIG. 6 shows lithium deposition on a polished copper disk electrode (1⅜″ diameter) over the course of 4 hours and 45 minutes.

### DETAILED DESCRIPTION

U.S. Patent Publication No. 2015/0014184 A1 to Swonger describes an electrolytic process for the continuous production of lithium metal from lithium carbonate or other lithium salts that dissociate in an acid electrolyte and release the non-lithium portion of the feed stock as gas. The Swonger electrolytic process uses an aqueous acid electrolyte and a lithium producing cell structure to continuously produce lithium metal from the lithium salt. The lithium producing cell structure includes a cell body, a cathode, an aqueous electrolyte solution containing lithium ion and an anion, and a composite layer intercalated between the cathode and the electrolyte aqueous solution. The composite layer comprises a lithium ion conductive glass ceramic (LIC-GC) and a lithium ion conductive barrier film (LI-BF) that isolates cathode-forming lithium from the electrolyte aqueous solution. The LIC-GC-BF composite allows for direct production of lithium metal from solution and direct deposition of lithium metal onto a clean cathode, without the need for an additional extraction process.

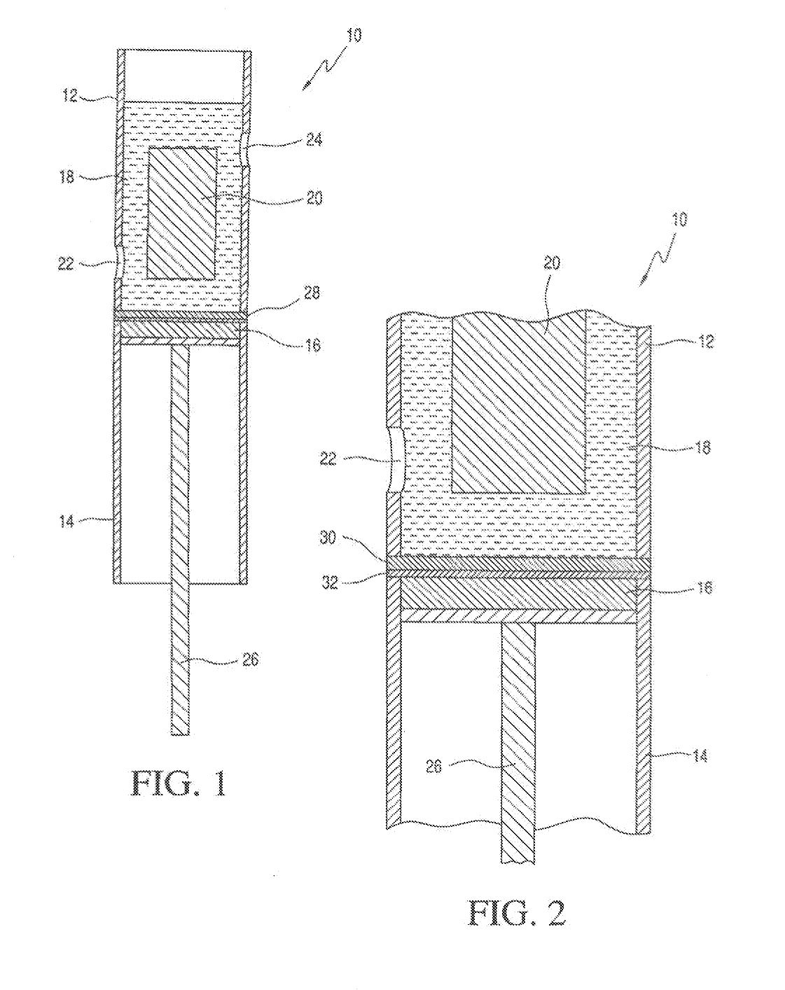

FIGS. 1 and 2 illustrate a lithium production process of U.S. Patent Publication No. 2015/0014184 A1 wherein lithium-rich electrolyte flows through an extraction cell. When potential is applied to the system, lithium metal builds up on a moving cathode below an intercalated composite layer. FIG. 1 shows a schematic elevation view of a lithium producing cell structure, and FIG. 2 is a schematic detail of the cell structure of FIG. 1.

In FIG. 1, and FIG. 2, the electrolytic cell 10 includes an upper section 12 and lower section 14. The cell 10 is characterized by a movable cathode 16 that transects a cross-section of the cell. The cathode 16 transposes an axis of cell 10, advancing as an electrolysis reaction takes place in electrolyte 18 above the cathode 16, through the LIC-GC-BF composite layer. Anode 20 is provided to the cell upper section 12. The cell section 12 above the cathode 16 is loaded with electrolyte 18 via inlet 22, electrolysis proceeds and spent electrolyte is discharged via outlet 24. The cathode 16 is in contact with the electrolyte 18 through a composite layer 28 intercalated between the cathode 16 and electrolyte 18. The composite layer 28 comprises a lithium ion conductive glass ceramic layer (LI-GC) 30 adjacent the electrolyte 18 and a lithium ion conductive barrier film (LI-BF) 32 interposed between the ceramic layer 30 and cathode 16. The composite 28 comprising barrier layer 32 and glass ceramic layer 30 isolates lithium forming at cathode 16 from electrolyte 18. Shaft 26 advances the cathode 16 and composite 28 as lithium metal is formed and deposited through the composite layer 28 onto the advancing cathode 16. The lithium metal produced at the solid cathode 16 can be drawn off as a pure metallic phase.

Suitable electrolyte 18 components include water-soluble lithium salts including but not limited to Li₂CO₃ and LiCl. To improve solubility, the lithium salts are dissolved in hydrated acid such as sulfuric acid and used as electrolyte 18 in the electrolytic cell 10. Lithium carbonate (Li₂CO₃) is the most readily available lithium salt and was used as feed stock for initial trials of cell 10.

U.S. Patent Publication No. 2015/0014184 A1 teaches that the use of sulfuric acid is important for efficient production of lithium metal from lithium carbonate because lithium carbonate is essentially insoluble in water and organic solvents, whereas lithium carbonate has a much higher solubility in a sulfuric acid solution. By disassociating the lithium carbonate and only placing the lithium ions into solution, the electrolyte solution remains stable and does not build up a concentration of the non-lithium ion portion of the feed stock. Lithium carbonate can be continuously fed into a tank outside of the electrolysis cell, venting off the CO₂ gas released by the sulfuric acid electrolyte and harvesting lithium metal from a cathode. This can be continuously operated or conducted as a batch process.

U.S. Patent Publication No. 2015/0014184 A1 discloses that some suitable components for its electrolytic cell 10 are described in U.S. Patent Publication No. 2013/0004852 A1.

Cathode 16 is characterized by the intercalated composite (Li-GC/Li-BF) 28 meaning the composite 28 is inserted or interposed between the cathode 16 and electrolyte 18. The cathode 16 advances along an axis of the cell 10 to transpire produced lithium through the composite 28 and to isolate cathode-deposited lithium. The cathode 16 comprises a suitable material that is non-reactive with lithium metal and the composite layer. The Li-GC/Li-BF composite layer 28 is a stationary barrier between the anode compartment and the lithium metal forming on the cathode. The cathode moves to accommodate the continuously thickening layer of lithium metal on the cathode.

As disclosed in U.S. Patent Publication No. 2015/0014184 A1, composite layer (Li-GC/Li-BF) 28 includes lithium ion conductive glass ceramic layer (LI-GC) 30 and lithium ion conductive barrier film (LI-BF) 32. The substantially impervious layer (LI-GC) 30 can be an active metal ion conducting glass or glass-ceramic (e.g., a lithium ion conductive glass-ceramic that has high active metal ion conductivity and stability to aggressive electrolytes that vigorously react with lithium metal. Suitable materials are substantially impervious, ionically conductive and chemically compatible with aqueous electrolytes or other electrolyte (catholyte) and/or cathode materials that would otherwise adversely react with lithium metal. Such glass or glass-ceramic materials are substantially gap-free, non-swellable and do not depend on the presence of a liquid electrolyte or other agent for their ionically conductive properties. They also have high ionic conductivity, at least 10⁻⁷ S/cm, generally at least 10⁻⁶ S/cm, for example at least 10⁻⁵ S/cm to 10⁻⁴ S/cm, and as high as 10⁻³ S/cm or higher so that the overall ionic conductivity of the multi-layer protective structure is at least 10⁻⁷ S/cm and as high as 10⁻³ S/cm or higher. The thickness of the layer is preferably about 0.1 to 1000 microns, or, where the ionic conductivity of the layer is about 10⁻⁷ S/cm, about 0.25 to 1 micron, or, where the ionic conductivity of the layer is between about 10⁻⁴ and about 10⁻³ S/cm, about 10 to 1000 microns, preferably between 1 and 500 microns, and more preferably between 50 and 250 microns, for example, about 150 microns.

Examples of glass ceramic layer (LiC-GC) 30 include glassy or amorphous metal ion conductors, such as a phosphorus-based glass, oxide-based glass, phosphorus-oxynitride-based glass, sulfur-based glass, oxide/sulfide based glass, selenide based glass, gallium based glass, germanium-based glass or boracite glass (such as are described D. P. Button et al., Solid State Ionics, Vols. 9-10, Part 1, 585-592 (December 1983); ceramic active metal ion conductors, such as lithium beta-alumina, sodium beta-alumina, Li superionic conductor (LISICON), Na superionic conductor (NASICON), and the like; or glass ceramic active metal ion conductors. Specific examples include LiPON, Li₃PO₄, Li₂S, SiS₂, Li₂S, GeS₂, Ga₂S₃ and Li₂O.

Suitable LiC-GC materials include a lithium ion conductive glass-ceramic having the following composition in mol percent: P₂O₅ 26-55%; SiO₂ 0-15%; GeO₂+TiO₂ 25-50%; in which GeO₂ 0-50%; TiO₂ 0-50%; ZrO₂ 0-10%; M₂O₃ 0-10%; Al₂O₃ 0-15%; Ga₂O₃0-15%; Li₂O₃-25% and containing a predominant crystalline phase comprising Li₁₊ₓ(M, Al, Ga)ₓ(Ge_{1-y}Ti_{y})₂₋ₓ(PO₄)₃ where X≤0.8 and 0≤Y≤1.0 and where M is an element selected from the group consisting of Nd, Sm, Eu, Gd, Tb, Dy, Ho, Er, Tm and Yb, and/or Li_{1+x+y}QₓTi₂₋ₓSi₃P_{3-y}O₁₂ where 0<X≤0.4 and 0<Y≤0.6, and where Q is Al or Ga. Other examples include 11Al₂O₃, Na₂O₁₁Al₂O₃, (Na, Li)ᵢ₊ₓTi₂₋ₓAlₓ(PO₄)₃ (0.6≤x≤0.9) and crystallographically related structures, Na₃Zr₂Si₂PO₁₂, Li₃Zr₂Si₂PO₄, Na₅ZrP₃O₁₂, Na₅TiP₃O₁₂, Na₃Fe₂P₃O₁₂, Na₄NbP₃O₁₂, Li₅ZrP₃O₁₂, Li₅TiP₃O₁₂, Li₅Fe₂P₃O₁₂ and Li₄NbP₃O₁₂ and combinations thereof, optionally sintered or melted. Suitable ceramic ion active metal ion conductors are described, for example, in U.S. Pat. No. 4,985,317 to Adachi et al.

U.S. Patent Publication No. 2015/0014184 A1 discloses that suitable LiC-GC materials also include a product from Ohara, Inc. (Kanagawa, JP), trademarked LIC-GC™ LISICON, Li₂O—Al₂O₃—SiO₂—P₂O₅—TiO₂ (LATP), and other materials with similarly high lithium metal ion conductivity and environmental/chemical resistance such as those manufactured by Ohara and others. See, for example, U.S. Pat. No. 8,476,174. U.S. Pat. No. 8,476,174 discloses a glass-ceramic comprising at least crystallines having a having a LiTi₂P₃O₁₂ structure, the crystallines satisfying 1<I_{A113}/I_{A104}≤2, wherein I_{A104} is the peak intensity assigned to the plane index 104 (2θ=20 to 21°), and I_{A113} is the peak intensity assigned to the plane index 113 (2θ=24 to 25°) as determined by X-ray diffractometry.

The lithium ion conductive barrier film 32 (Li-BF) of U.S. Patent Publication No. 2015/0014184 A1 is a lithium metal ion conductive film or coating with high lithium metal ion conductivity, typically 1.0 mS/cm to 100 mS/cm. A high lithium ion transference number (t₊) is preferred. Low t₊Li⁺ electrolytes will hinder performance by allowing ion concentration gradients within the cell, leading to high internal resistances that may limit cell lifetime and limit reduction rates. Transference numbers between t₊=0.70 and t₊=1.0 are preferred. The lithium ion conductive barrier film is non-reactive to both lithium metal and the LI-GC material.

The LI-BF film 32 includes an active metal composite, where “active metals” are lithium, sodium, magnesium, calcium, and aluminum used as the active material of batteries. Suitable LI-BF material includes a composite reaction product of active metal with Cu₃N, active metal nitrides, active metal phosphides, active metal halides, active metal phosphorus sulfide glass and active metal phosphorous oxynitride glass (Cu₃N, L₃N, Li₃P, LiI, LiF, LiBr, LiCl and LiPON). U.S. Patent Publication No. 2015/0014184 A teaches that the LI-BF material must also protect against dendrites forming on the cathode from coming in contact with the LI-GC material. This may be accomplished by creating physical distance between the cathode and LI-GC and/or providing a physical barrier that the dendrites do not penetrate easily. One preferred LI-BF film is a physical organogel electrolyte produced by in situ thermo-irreversible gelation and single ion-predominant conduction as described by Kim et al. in Scientific Reports (article number: 1917 doi:10.1038/srep01917). This electrolyte has t₊=0.84 and conductivity of 8.63 mS/cm at room temperature. This organogel electrolyte can be set up in a porous membrane to provide additional structure and resistance to dendrite penetration. Typical porous membrane thickness is 1 μm to 500 μm, for example 20 μm. Acceptable porous membrane includes HIPORE polyolefin flat-film membrane by Asahi Kasei E-materials Corporation.

The continuous lithium metal production process of U.S. Patent Publication No. 2015/0014184 A1 can utilize inexpensive lithium carbonate or an equivalent source of lithium ions to produce lithium metal directly from the acid solution used to leech lithium metal out of spodumene ore or other natural lithium sources.

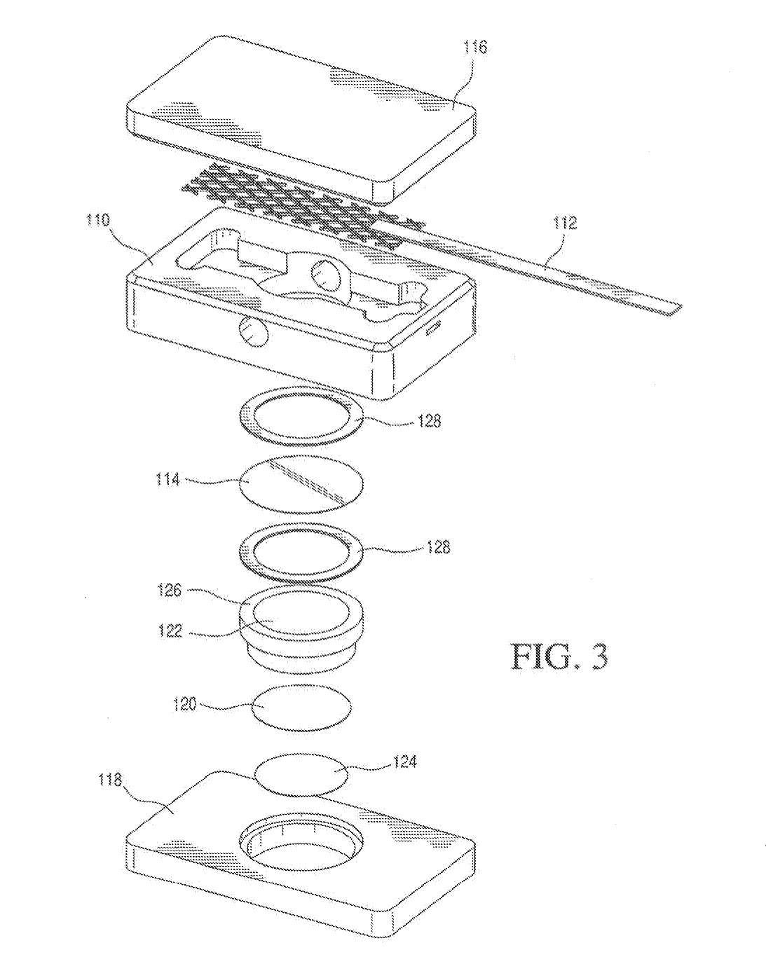

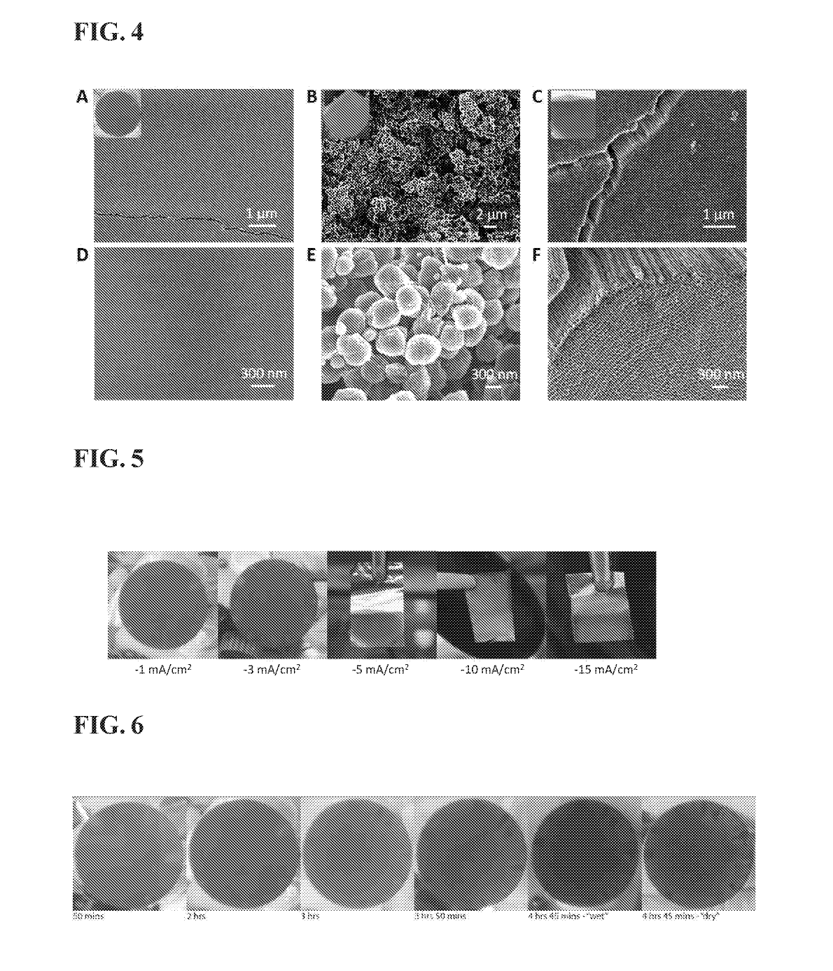

An example process of U.S. Patent Publication No. 2015/0014184 A1 utilizes the cell shown schematically in FIG. 3. The cell 110 includes cell cover 116, retainer 118, Pt anode 112, cathode 124 and a LiC-GC conductive glass 114 with lithium ion conductive barrier film 120 incorporated into a porous polyolefin flat-film membrane 122. The supported LiC-GC-BF multilayer is intercalated between cathode 124 and a lithium ion-rich electrolyte 18 (as shown in FIGS. 1 and 2). The cell further comprises supporting Teflon® sleeve structure 126 with gaskets 128. One gasket seals between the LiC-GC and the housing to prevent leakage of the electrolyte from the anode compartment into the cathode compartment. The other gasket allows for even compression of the LiC-GC by the Teflon sleeve to prevent breakage of the LiC-GC plate.

The cell 110 includes anode 112 that is a platinized titanium anode, 1″×4″ rhodium and palladium jewelry plating. The cathode is a palladium cathode disc fabricated in-house, 1.4 inch round. The LiC-GC 114 material is LICGC® G71-3 N33: DIA 2 IN×150 μm tape cast, 150 μm thick, 2 inch round from Ohara Corporation, 23141 Arroyo Vista, Rancho Santa Margarita, Calif. 92688.

The lithium ion conducting gel electrolyte 120 is fabricated from: a PVA-CN polymer supplied by the Ulsan National Institute of Science and Technology in Ulsan South Korea, Dr. Hyun-Kon Song, procured from Alfa Aesar, stock number H61502; LiPF₆ (lithium hexafluorophosphate), 98%; EMC (ethyl methyl carbonate), 99%, from Sigma Aldrich, product number 754935; EC (ethylene carbonate), anhydrous, from Sigma Aldrich, product number 676802; and a porous membrane, ND420 polyolefin flat-film membrane from Asahi Corp.

The Li-BF barrier layer 120 is fabricated in an argon purged glove bag. The glove bag is loaded with all materials, precision scale, syringes, and other cell components then filled and evacuated four times before the start of the electrolyte fabrication process.

The organogel electrolyte is mixed as follows: 4.0 ml of EMC is liquefied by heating to about 140° F. and placed in a vial. 2.0 ml of the EMC is then added-to the vial, 0.133 g (2% wt) PVA-CN polymer is added to the vial and the mixture is agitated for 1 hour to dissolve the PVA-CN. Then 0.133 g (2% wt) FEC is added as SEI-forming additive, 0.972 g (1M) LiPF₆ is then added and mixed to complete the organogel electrolyte mixture. The electrolysis cell is then assembled inside the glove bag. With the LiC-GC and gaskets in place, the anode and cathode compartments are sealed from each other. The organogel electrolyte mixture is used to wet the cathode side of the LiC-GC, the HIPORE membrane is placed on the cathode side of the LiC-GC and wetted again with organogel electrolyte mixture. The cathode disc is then placed on top of the organogel mixture. The cell is placed in a Mylar® bag and sealed while still under argon purge. The sealed Mylar® bag with assembled cell is then placed in an oven at 60° C. for 24 hours to gel the electrolyte.

The electrolysis cell 110 is removed from the oven and placed in the argon purged glove bag, and allowed to cool to room temperature. Clear polypro tape is used to seal the empty space above the cathode disc and secure the electrode wire. The electrolysis cell 110 is now ready for use, is removed from the glove bag, and is connected to the electrolyte circulating system.

An electrolyte 18 is prepared with 120 g of lithium carbonated in 200 ml of deionized water and 500 ml of 20% wt sulfuric acid. The sulfuric acid is slowly added to the lithium carbonate suspension and mixed well. Undissolved lithium carbonate is allowed to settle. A supernatant is collected from the stock solution, an 18% wt lithium stock solution. The 18% wt lithium solution has a measured pH of 9. Solution pH is lowered by addition of 20% wt sulfuric acid. Again, the sulfuric acid is added slowly to minimize foaming. The 18% wt lithium stock solution is adjusted to pH 4.5. Preferred pH is between pH 3.0 and pH 4.5, most preferred is between pH 3.0 and pH 4.0, but the process can be run at a pH of 7.0 or below. A pH above 7.0 will result in carbonate in solution.

The electrolyte mixture is then poured into the circulating system. The circulating pump is primed and solution circulated for 30 minutes to check for leaks.

The lithium ion-rich electrolyte 18 flows through the top half of cell 110 over the LiC-GC-BF multilayer 114/120 and past anode 112. When potential is applied to the system, lithium metal builds up on the moving cathode below the LiC-GC-BF multilayer 114/120 system.

A Gamry Reference 3000 Potentiostat/Galvanostat/ZRA is attached to the cell 110. At voltages of −3 to −6 volts there is no significant activity. When the voltage is raised to −10V, the system responds. Amperage draw increases when the voltage is raised to 11 vdc. No gassing on the anode side of the cell was noted at 11 vdc. The Gamry Reference 3000 would not go below −11 vdc. Since no gassing occurred at −11 vdc, the reduction rate could most likely be much higher if voltage were increased. An even higher voltage and reduction rate are preferable if achieved with negligible oxygen production at the anode. The pH of the electrolyte at time zero is 4.46. The pH of the solution decreases to 4.29 after 35 minutes, and is 4.05 at the end of the experiment. The lowering pH indicates lithium ion removal from the electrolyte.

An amperage draw of −20 mA is noted at the start of the experiment. The amperage draw slowly increases to −60 mA after 30 minutes. Amperage holds fairly steady at this value for another 30 minutes. Experiment timer and graph are paused for 30 minutes to extend experiment (voltage held at −11 vdc). After approximately 65 minutes of run time, a large amperage spike and sudden vigorous gassing is noted on the anode side of the cell. This is indicative of LiC-GC-BF 114/120 membrane failure.

Rapid gassing and bright white flame is observed when the cell 110 is opened and cathode 124 side is exposed to electrolyte leaking through the LiC-GC-BF 114/120, evidencing that the cell produces lithium metal by electrolysis of lithium ions in a sulfuric acid aqueous solution, through a LiC-GC-BF 114/120 membrane system.

The present disclosure modifies the process of U.S. Patent Publication No. 2015/0014184 A1 to produce high purity smooth lithium metal thin-films having a controlled thickness and morphology. Specifically, the present disclosure is based on the use, optimization and variation of electrical parameters, and materials used in the cell of U.S. Patent Publication No. 2015/0014184 A1.

The present disclosure provides a lithium producing electrolytic cell based on U.S. Patent Publication No. 2015/0014184 A1, assembled in an argon purged glove box and an aqueous electrolyte feeding container placed outside the argon purged glove box and connected to a cell by plastic tubing equipped with a hydraulic pump and valves.

The present disclosure utilizes a Gamry Reference 3000 Potentiostat/Galvanostat/ZRA attached to a cell with a reference electrode to control the applied potential. As described in U.S. Patent Application No. 62/168,770, the cell includes a sleeve and a cell body. A movable cathode transects a cross-section of the cell. The cathode transposes an axis of the cell and can be positioned in catholyte above an LIC-GC membrane. Anode is provided in lower cell body. The portion of cell body below the LIC-GC membrane is loaded with lithium ion containing electrolyte via inlet, electrolysis proceeds and spent electrolyte is discharged via outlet. Lithium ions are conducted from the lithium ion containing electrolyte through the LIC-GC membrane and catholyte to the cathode. The cathode is spaced apart from the LIC-GC membrane intercalated between the cathode and electrolyte. The LIC-GC membrane comprises a lithium ion conductive glass ceramic layer (LIC-GC) interposed between the lithium ion containing electrolyte and lithium ion conducting catholyte. Cathode support, driven by a servo motor, advances the cathode as required to maintain spacing between lithium metal formed on the cathode and the LIC-GC membrane, and also to withdraw the cathode for lithium metal removal. Lithium metal produced at the cathode may be drawn off as a pure metallic phase.

The reference electrode is selected from a group of: saturated silver chloride (Ag/AgCl) aqueous electrode, free standing lithium metal foil and lithium metal film on copper substrate. An Ag/AgCl electrode is used as a reference electrode in the aqueous electrolyte feeding container. Free standing lithium metal foil and lithium metal film on copper substrate are used as reference electrodes in an organic electrolyte compartment of the cell. Electrolytic deposition of lithium metal occurs at voltages of 3.3V vs Ag/AgCl and 0V vs Li.

The present disclosure provides a method in which lithium is electrolytically deposited at or near room temperature from an electrolyte mixture separated by an inorganic membrane. The inorganic membrane is only conductive to lithium ions and is impermeable to water and cations of other common base metals such as Fe, Ca, Na, K, Cu, Ba, and Mg. Lithium cations are transported across the membrane (LiSICON membrane from Ohara) from an aqueous solution containing sulfuric acid and a lithium salt (such as lithium carbonate, LiCl, LiF, or LiNO₃), into an organic electrolyte of 1.0 M lithium hexafluorophosphate (LiPF₆) in dimethyl carbonate (“DMC”). The organic electrolyte is in contact with the cathode. The cathode may be comprised of any material that does not alloy with lithium such as copper or stainless steel. Lithium ions transported across the membrane are deposited on the cathode to form a lithium metal film.

The morphology of the lithium metal film can be controlled by the current rate used for electrodeposition as shown in FIG. 5. The images in FIG. 5 show SEM photographs of lithium films deposited on a copper substrate at −1 mA/cm², −3 mA/cm², −5 mA/cm², −10 mA/cm², and −15 mA/cm².

A low current rate of −1 mA/cm² leads to the deposition of a smooth surface film as shown in FIG. 5(A). In contrast, higher current rates of −3 mA/cm² (as shown in FIG. 5(B)) and −5 mA/cm² (as shown in FIG. 5(C)) produce sphere- and rod-like structured films, respectively.

FIG. 5 demonstrates that dendrite-free and optically smooth lithium films were produced on the copper substrate at current rates ranging from 1 mA/cm² up to 15 mA/cm². The copper substrate in FIG. 5 was pre-treated by etching the substrate in concentrated sulfuric acid (98 wt %) for two seconds, rinsing the substrate with deionized water, and air drying the substrate, in order to remove impurities from the surface and produce smooth lithium films.

As shown in FIG. 5(E), dendrite growth occurs at a current rate of −15 mA/cm² when the pre-treated copper substrate is used.

FIG. 6 shows the progression of lithium deposition on a polished copper disk electrode (1⅜″ diameter) over the course of 4 hours and 45 minutes. The deposition was performed in a 1.0M electrolyte solution of LiPF₆ in DMC with a current density of −1 mA/cm². The “dry” image was taken after the electrode was rinsed with DMC and dried under a flow of Argon for 5 minutes. The markings on the edges are from the Teflon® pegs that hold the electrode in the organic electrolyte solution, preventing it from contacting the LiSICON membrane. As shown in FIG. 6, the smoothness of the lithium films can be preserved during the entire deposition process, up to 4 hours and 45 minutes, which corresponds to a 25 μm thick deposit. These results suggest that much thicker, dendrite-free lithium films can be produced using the present method.

The high purity smooth lithium metal thin film may be used in any application where an ultra thin, high quality lithium film is required. For example, the high purity smooth lithium metal thin film may be used in a microbattery or a low power device that requires thin high-purity lithium films having a thickness less than 40 μm. Microbatteries including the high purity smooth lithium metal thin film can be coupled to energy harvesting electronics such as piezo electronics and photovoltaics, as well as be integrated into microelectronics and nanosensors. The high purity smooth lithium metal thin film may also be used in a lithium metal anode of a battery.

The present process can deposit lithium films in the range of 1-50, 50-100, and 100-1000 nm as well as 1-10, 10-100, and 100-1000 μm. These films can also be used as electrodes in electrochemical capacitors, metacapacitors, LED television screens such as Panasonic's TH-42AS700A LED television, and LED flashlights.

The present process can also be used to form lithium-metal alloys (alloys of lithium with Al, Ni, Mg, Sn, or Si) at room temperature. If a metal which is known to alloy with lithium is used as the cathode, lithium will alloy into the metal's crystal structure instead of depositing onto its surface. In the case of Li—Al alloys, the presence of Na or K impurities has shown to reduce the toughness and ductility at room temperature in a linear fashion. The present process can effectively reduce base metals content to 0 ppm. In particular, the present process eliminates the content of Na, K, Fe, Ca, Mg and other common metals, thus allowing for a new low-temperature route to form high-strength Li—Al alloy materials.

The invention is claimed as follows:

1. A lithium metal film,
wherein the lithium metal film is free of dendrites and is optically smooth.

2. The lithium metal film of claim 1, wherein the lithium metal film is formed using a selective lithium ion conducting layer.

3. The lithium metal film of claim 1, wherein the lithium metal film has a thickness of about 1 nm to about 1000 μm.

4. The lithium metal film of claim 3, wherein the thickness is about 1 nm or more and less than about 40 μm.

5. The lithium metal film of claim 3, wherein the thickness is about 25 μm.

6. The lithium metal film of claim 1, wherein the lithium metal film has a smooth surface morphology.

7. The lithium metal film of claim 1, wherein the lithium metal film comprises spherical structures.

8. The lithium metal film of claim 1, wherein the lithium metal film comprises nano-rod structures.

9. A lithium metal film, wherein the lithium metal film is optically smooth, and wherein d<λ/(8 cos θ), where d is a surface roughness, λ is the wavelength of an incident illumination, and θ is an angle of incidence of the incident illumination.

10. The lithium metal film of claim 9, wherein the surface roughness is a root-mean-square roughness height measured from a reference plane.

11. An electrode comprising:
a substrate; and
a lithium metal film provided on the substrate,
wherein the lithium metal film is free of dendrites and is optically smooth.

12. The electrode of claim 11, wherein the lithium metal film has a thickness of about 1 nm to about 1000 μm.

13. The electrode of claim 11, wherein the substrate comprises a material that does not alloy with lithium.

14. The electrode of claim 11, wherein the substrate comprises a material selected from the group consisting of: copper and stainless steel.

15. The electrode of claim 11, wherein the substrate is pre-treated by etching the substrate in concentrated sulfuric acid (98 wt %) for two seconds, rinsing the substrate with deionized water, and air drying the substrate before the lithium metal film is provided thereon.

16. The electrode of claim 11, wherein the lithium metal film is formed using a selective lithium ion conducting layer.

17. A lithium alloy comprising:
a substrate; and
a lithium metal film provided on the substrate,
wherein the lithium metal film is free of dendrites and is optically smooth, and
wherein the substrate comprises a material that alloys with lithium.

18. The lithium alloy of claim 17, wherein the substrate comprises aluminum.

19. The lithium alloy of claim 17, wherein the substrate comprises a material selected from the group consisting of silicon and tin.

20. The lithium alloy of claim 17, wherein the substrate comprises a material selected from the group consisting of carbon, titanium, magnesium and bismuth.

21. The lithium alloy of claim 17, wherein the lithium metal film is formed using a selective lithium ion conducting layer.

22. A battery comprising:
a cathode;
an anode; and
an electrolyte,
wherein a lithium metal film is provided on at least one of the cathode and the anode, and
wherein the lithium metal film is free of dendrites and is optically smooth.

23. The battery of claim 22, wherein the battery is selected from the group consisting of: a lithium primary battery, a secondary battery, and a microbattery.

24. The battery of claim 22, wherein the lithium metal film has a thickness of about 1 nm to about 1000 μm.

25. The battery of claim 22, wherein the lithium metal film is formed using a selective lithium ion conducting layer.

26. A method of obtaining a desired morphology of a lithium metal film, comprising:
electrolytically depositing lithium metal using a selective lithium ion conducting layer, and
controlling a current rate of the electrolytic deposition to obtain a desired morphology.

27. The method of claim 26, wherein the current rate is controlled within a range of −1 mA/cm² to −10 mA/cm².

28. The method of claim 26, wherein the current rate is controlled within a range of −1 mA/cm² to −4.5 mA/cm².
